(19) United States
(12) Patent Application Publication
(10) Pub. No.: US 2026/0077718 A1
(43) Pub. Date: Mar. 19, 2026

(54) Methods, Apparatuses, Controllers, Vehicles, and Program Products for Displaying Obstacles

(71) Applicant: Robert Bosch GmbH, Stuttgart (DE)

(72) Inventors: Xingyu Liu, Shanghai (CN); Huaizhu Wang, Shanghai (CN)

(21) Appl. No.: 19/326,316

(22) Filed: Sep. 11, 2025

(30) Foreign Application Priority Data
Sep. 13, 2024 (CN) 2024 1128 7545.5

(51) Int. Cl. B60R 1/22; G01S 13/931; G06T 7/60; G06T 11/00; G06V 20/58

(52) U.S. Cl. CPC B60R 1/22; G01S 13/931; G06T 7/60; G06T 11/00; G06V 20/58; B60R 2300/301; B60R 2300/806; B60R 2300/8093; G06T 2207/30261

(57) ABSTRACT

Methods, apparatuses, controllers, vehicles, and program products for displaying obstacles are disclosed. The method includes acquiring an environmental image captured by cameras of a vehicle and perception information of a radar of the vehicle. The method further includes determining, based on the perception information, virtual objects of obstacles around the vehicle. In addition, the method also includes displaying a vehicle image of the vehicle, an environmental image, and a virtual object of an obstacle on a display screen. In this way, an environmental image and a virtual object of an obstacle can be displayed on a display screen at the same time, allowing the user to more clearly determine the obstacles around the vehicle through the content displayed on the display screen and thereby improving the user experience.

This application claims priority under 35 U.S.C. § 119 to application no. CN 2024 1128 7545.5, filed on Sep. 13, 2024 in China, the disclosure of which is incorporated herein by reference in its entirety.

The present disclosure relates to the technical field of vehicles, and more particularly to methods, apparatuses, controllers, vehicles, and program products for displaying obstacles.

### BACKGROUND

With the development of economy, vehicles are becoming more and more commonplace in our lives. When a user is driving a vehicle, they need to observe and pay attention to the environment around the vehicle in real time to avoid violations or traffic accidents. There are blind spots in the user's observation of the vehicle's surroundings. For example, due to the vehicle's own obstruction, the user cannot observe objects at close range around the vehicle. This will affect the driving decisions of the user, which in turn will affect driving safety.

As vehicles become increasingly intelligent, more and more vehicles are equipped with cameras that can capture images of the environment around the vehicle. These images can be presented to users through devices such as displays on vehicle terminals, allowing users to have a more comprehensive understanding of the true state of the environment. In some cases, the results of the vehicle's cameras capturing or perceiving of the environment may be inaccurate.

### SUMMARY

The present disclosure provides a method, apparatus, controller, vehicle, and program product for displaying obstacles.

In a first aspect of the present disclosure, a method for displaying obstacles is provided, the method comprising acquiring an environmental image captured by cameras of a vehicle and perception information of a radar of the vehicle. The method further comprises determining, based on the perception information, virtual objects of obstacles around the vehicle. In addition, the method also comprises displaying a vehicle image of the vehicle, an environmental image, and a virtual object of an obstacle on a display screen.

In a second aspect of the present disclosure, an apparatus for displaying obstacles is provided. The apparatus comprises a first acquisition unit configured to acquire an environmental image captured by cameras of a vehicle. The apparatus further comprises a second acquisition unit configured to acquire perception information of a radar of the vehicle. The apparatus further comprises an image determination unit configured to determine a virtual object of an obstacle around the vehicle based on the perception information. In addition, the apparatus further comprises a display unit configured to display a vehicle image of the vehicle, an environment, and virtual objects of obstacles.

In a third aspect of the present disclosure, a controller is provided. The controller may comprise: at least one processor; and a memory coupled to the at least one processor and having instructions stored thereon that, when executed by the at least one processor, cause the controller to execute the method provided according to the first aspect of the present disclosure.

According to a fourth aspect of the present disclosure, a vehicle is provided. The vehicle includes a controller provided according to the third aspect of the present disclosure.

In a fifth aspect of the present disclosure, a machine-readable storage medium is provided. The machine-readable storage medium has computer-executable instructions stored thereon, wherein the computer-executable instructions are executed by a processor to implement the method provided according to the first aspect of the present disclosure.

In a sixth aspect of the present disclosure, a computer program product is provided. The computer program product may include: computer-executable instructions that, when executed, cause a computer to perform the steps of the method provided according to the first aspect of the present disclosure.

It will be understood that the content described in the Summary is not intended to limit key or important features of the examples of the present disclosure, nor is it intended to limit the scope of the present disclosure. Other features of the present disclosure will become readily understood by the following description.

### BRIEF DESCRIPTION OF THE DRAWINGS

The exemplary examples of the present disclosure will be described in further detail in conjunction with accompanying drawings in order to further clarify the above-mentioned and other objectives, features and advantages of the present disclosure, wherein in the exemplary examples of the present disclosure, the same reference number typically represents the same parts.

FIG. 1 shows a schematic diagram of an example environment in which multiple examples of the present disclosure may be implemented;

FIG. 2A shows a schematic view of a scenario of capturing an environmental image through cameras according to some examples of the present disclosure;

FIG. 2B shows a schematic view showing content displayed on a display screen according to some examples of the present disclosure;

FIG. 3 shows a flow chart of a method for displaying obstacles according to some examples of the present disclosure;

FIG. 4 shows a schematic view of a scenario for displaying obstacles according to some examples of the present disclosure;

FIG. 5 shows a schematic view of perception information according to some examples of the present disclosure;

FIG. 6 shows a schematic view showing content displayed on a display screen according to some examples of the present disclosure;

FIG. 7 shows a schematic view showing other content displayed on a display screen according to some examples of the present disclosure;

FIG. 8 shows a flow chart of a method for displaying obstacles according to some examples of the present disclosure;

FIG. 9 shows a block diagram of an apparatus for displaying obstacles according to some examples of the present disclosure; and

FIG. 10 is a block diagram of a controller that may implement a plurality of examples of the present disclosure.

In general, the same reference numerals are used throughout the accompanying drawings and in the specific examples appended thereto to denote the same or similar components. The accompanying drawings need not be drawn to scale. The dimensions of the components or regions in the accompanying drawings may be enlarged for illustration.

### DETAILED DESCRIPTION

The examples of the present disclosure will be described in further detail below with reference to the accompanying drawings. While certain examples of the present disclosure are shown in the accompanying drawings, it should be understood that the present disclosure may be implemented in various forms and should not be construed as being limited to the examples set forth herein, rather these examples are provided for a more thorough and complete understanding of the present application. It should be understood that the accompanying drawings and examples of the present disclosure are for exemplary purposes only and are not intended to limit the scope of protection of the present disclosure.

In the description of the examples of the present disclosure, the term “comprise” and other similar expressions should be understood as open-ended inclusion, that is, “comprising but not limited to.” The term “based on” should be understood as “at least partially based on.” The term “one example” or “this example” should be understood as “at least one example.” The terms “first,” “second,” etc. may refer to different or the same object. The text below may comprise other specific and implicit meanings.

The vehicle (sometimes referred to as a vehicle) in the examples of the present disclosure is a vehicle in a broad sense, which can be a way of transportation (e.g., a car, truck, motorcycle, airplane, train, ship, etc.), an industrial vehicle (e.g.: a forklift, trailer, tractor, etc.), an engineering vehicle (e.g., an excavator, a bulldozer, a crane, etc.), agricultural equipment (e.g., a lawn mower, a harvester, etc.), amusement equipment, a toy vehicle, etc. The examples of the present disclosure do not specifically limit the type of vehicle. In examples of the present disclosure, the vehicle may be configured with cameras through which the vehicle may acquire environmental images around the vehicle. In the examples and drawings of the present disclosure, an automobile is taken as an example to illustrate the solutions provided by the present disclosure. It should be understood that this is only for the convenience of explanation and should not be construed as a limitation on the solutions provided by the present disclosure.

As previously noted, the vehicle may capture images of the environment around the vehicle via a camera. In some cases, the images captured by the cameras may not clearly reflect the actual state of the environment. For example, at night, due to insufficient light, the image of the environment around the vehicle captured by the cameras may be blurry, and the user cannot judge the specific conditions of the environment around the vehicle through the image. For another example, the vehicle's cameras may malfunction, causing the user to be unable to obtain images of the surrounding environment. This will prevent the user from accurately understanding the true state of the environment, which in turn may affect the user's driving safety.

To this end, examples of the present disclosure suggest a method for displaying obstacles. In examples of the present disclosure, the environmental image captured by the vehicle's cameras and the perception information of the vehicle's radar can be obtained, the virtual objects of obstacles around the vehicle can be determined based on the perception information of the radar, and the vehicle image of the vehicle, the captured environmental image, and the virtual objects of the obstacles can be displayed on a display screen.

In this way, when presenting the vehicle's surrounding environment to the user on the display screen, not only the environmental images captured by the vehicle's cameras but also the radar's perception information is taken into consideration. Virtual objects of obstacles determined based on the radar's perception information can be displayed on the display screen, thereby presenting the actual situation of the vehicle's surrounding environment to the user more intuitively on the display screen and improving the user experience. In addition, when the environmental image cannot accurately reflect the location of the obstacle, the virtual object of the obstacle can be determined through the radar's perception information and presented on the display screen, making the presented surrounding environment more accurate and thereby improving the user's driving experience and driving safety.

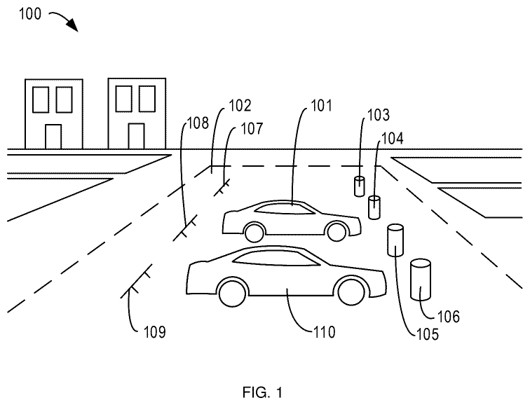

FIG. 1 shows a schematic diagram of an example environment 100 in which a plurality of examples of the present disclosure may be implemented. As shown in FIG. 1, the environment 100 may include a vehicle 101, which may be configured with cameras and a display screen. The cameras of the vehicle 101 can collect images of the environment around the vehicle and the display screen can display the environmental images captured by the cameras. The cameras configured for the vehicle 101 may comprise but are not limited to a front-view camera, a left-side camera, a right-side camera, and a rear-view camera. The cameras may be installed around the vehicle body, and the vehicle 101 may achieve panoramic shooting of the vehicle's surroundings through the cameras installed around the vehicle body.

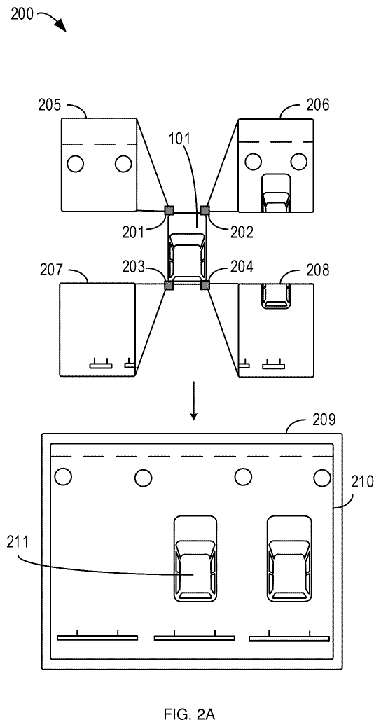

In the environment 100, the vehicle 101 may be located in a parking area 102 surrounded by dotted lines, and the area surrounding vehicle 101 may include obstacles 103 to 109 and vehicle 110. During the parking of the vehicle 101, the vehicle 101 may capture an environmental image around the vehicle 101 through the configured cameras. The environmental image may include images corresponding to obstacles 103 to 109 and vehicle 110. The environmental image acquired by the cameras may be displayed on a display configured in the vehicle. By way of example, this process is illustrated in FIG. 2A.

FIG. 2A shows a schematic view of a scenario 200 of capturing an environmental image through cameras according to some examples of the present disclosure. In the scenario 200, the vehicle 101 may be configured with a camera 201, a camera 202, a camera 203, and a camera 204. The camera 201 may be deployed at the left front of the vehicle 101 and may capture the environment at the left front of the vehicle 101 to obtain an environmental image 205. The camera 202 may be deployed at the right front of the vehicle 101 and may capture the environment at the right front of the vehicle 101 to obtain an environmental image 206. The camera 203 may be deployed at the left rear of the vehicle 101 and may capture the environment at the left rear of the vehicle 101 to obtain an environmental image 207. The camera 204 may be deployed at the right rear of the vehicle 101 and may capture the environment at the right rear of the vehicle 101 to obtain an environmental image 208.

In some examples, the environmental image 205, the environmental image 206, the environmental image 207, and the environmental image 208 may be displayed together on a display screen 209 configured in the vehicle 101. In some examples, the environmental image 205, the environmental image 206, the environmental image 207, and the environmental image 208 may be merged or processed to form a panoramic image 210 of the vehicle's surroundings and the panoramic image 210 may be displayed on the display screen 209. In some examples, the display screen 209 may further display a vehicle image 211 corresponding to the vehicle 101, which may be displayed, for example, at the center of the panoramic image 210.

It should be understood that the enumeration of the positions and numbers of cameras in the examples of the present disclosure is for illustration only and should not be construed as a limitation to the examples of the present disclosure. For example, in some examples, the cameras configured for the vehicle 101 can be located in front of, behind, and at the left and right rearview mirror positions of the vehicle 101, respectively, and are used to capture environmental images in front of, behind, on the left, and on the right side of the vehicle 101, respectively. These environmental images can be merged and processed to form a panoramic image of the vehicle's surroundings.

In examples of the present disclosure, the vehicle 101 may be configured with a radar, which may include but is not limited to a LIDAR, a mm wave radar, an ultrasonic radar, etc. The radar can transmit a detection signal and receive an echo signal reflected by an obstacle. Based on the echo signal, the radar can sense obstacles in the environment, such as the location, height, outline, size, and other information of the obstacle. In examples of the present disclosure, based on the perception information of the radar, a virtual object of an obstacle around the vehicle can be determined, and the virtual object can be, for example, a line, a two-dimensional image, or a three-dimensional model. The virtual object may be displayed on the display screen 209 together with the environmental image captured by the cameras. By way of example, this process is illustrated in FIG. 2B.

FIG. 2B shows a schematic view showing content displayed on a display screen 209 in some examples of the present disclosure. Referring to FIG. 2B, the display screen 209 may display the panoramic image 210, the vehicle image 211, and the virtual objects 221 to 223. The virtual objects 221 to 223 may be determined based on the radar perception information of obstacles around vehicle 101. The virtual object 221 may correspond to an obstacle 103 in the environment 100, the virtual object 222 may correspond to an obstacle 104 in the environment 100, and the virtual object 223 may correspond to an obstacle 108 in the environment 100.

It should be understood that the above description of the environment in which the examples of the present disclosure can be implemented in combination with FIGS. 1, 2A, and 2B is only an example of the examples of the present disclosure and should not be construed as a limitation on the solutions provided by the present disclosure. For example, in some examples, vehicle 101 may drive on a road. In some examples, the environment 100 may include more or fewer obstacles. In some examples, the vehicle 101 may be equipped with more or fewer cameras, and the cameras equipped in the vehicle 101 may be fisheye cameras, high-definition cameras, or other types of cameras. In some examples, the cameras in vehicle 101 may be deployed at other locations in the vehicle.

In some examples, the display screen 209 may be a display screen configured for an in-vehicle terminal of the vehicle 101 or may be a display screen of other types of terminal devices. Terminal devices may include but are not limited to personal computers, server computers, handheld or laptop devices, mobile devices (e.g., mobile phones, personal digital assistants (PDAs), media players, etc.), consumer electronics, minicomputers, mainframe computers, cloud computing resources, etc. The terminal device may be deployed in the vehicle 101 or may be deployed outside the vehicle 101. The terminal device can acquire the camera of vehicle 101 and the captured environmental images and/or the perception information of the radar of vehicle 101 from vehicle 101 in a wired or wireless manner and display the environmental images and/or virtual objects on the display screen of the terminal device. In some examples, the terminal device may process the image and/or perception information before the image and/or virtual object is displayed through the display screen.

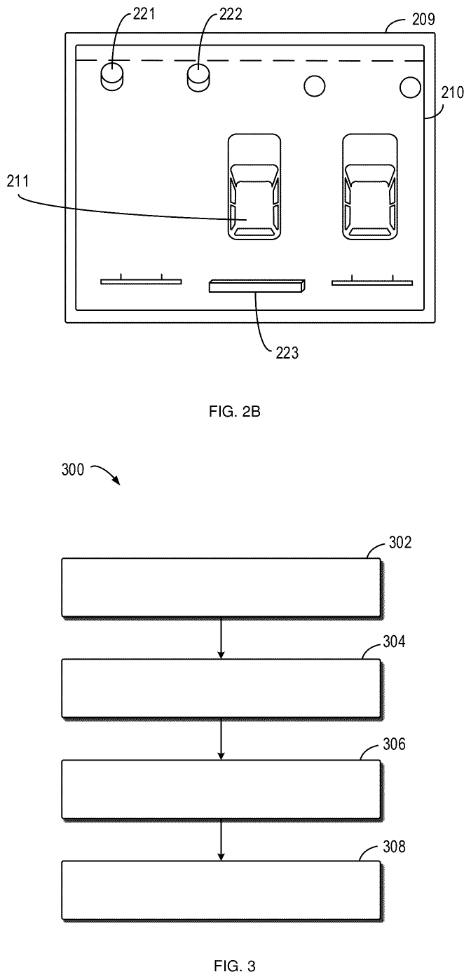

FIG. 3 shows a flow chart of a method 300 for displaying obstacles according to some examples of the present disclosure. The method 300 may be performed by a controller, which may be a chip or chip system in the vehicle, such as an electronic control unit (ECU) in the vehicle 101. In some examples, the controller may also be a device independent of the vehicle. For ease of illustration, the method 300 is exemplarily described below by taking a controller as the execution entity. As shown in FIG. 3, the method 300 may include blocks 302 to 308.

In block 302, the controller may acquire environmental images acquired by cameras of the vehicle. The vehicle may be equipped with one or more cameras and the environmental images may be captured by the one or more cameras. Exemplarily, the vehicle may be, for example, the vehicle 101 in FIG. 2A, the cameras of the vehicle may include cameras 201 to 204, and the environmental images may include environmental images 205 to 208. In some examples, the vehicle may be configured with a plurality of cameras and the controller may acquire one or more environmental images acquired by one or more of the cameras therein.

In block 304, the controller may acquire perception information from a radar of the vehicle. The perception information may be information collected by the radar and related to obstacles around the vehicle. Exemplarily, the radar's perception information may be an echo signal after the detection signal emitted by the radar is reflected by an obstacle. Based on the echo signal, information such as the position, height, outline, and/or size of the obstacle may be determined. In some examples, the radar may process the received echo signal to determine information such as the specific location, height, outline, and/or size of the obstacle in the environment, and the controller may obtain perception information such as the location, height, outline, and/or size of the obstacle as determined by the radar. In some examples, the radar may generate point cloud data after sending out a detection signal and receiving an echo signal and the perception information acquired by the controller may be the point cloud data. It should be understood that the perception information described above is by way of example only and does not constitute a limitation of the present disclosure.

In block 306, the controller determines virtual objects of obstacles around the vehicle based on the perception information. The virtual object may be a line, a two-dimensional image or a three-dimensional model indicating an obstacle. For example, the obstacle may be a pedestrian and the virtual object may be a model or image of the person. For another example, the obstacle may be a vehicle and the virtual object may be a model or image of the vehicle. In some examples, the virtual objects may be predefined, e.g., the controller may store a plurality of predefined different types of virtual objects in memory, which the controller may match with the perception information to determine the virtual objects indicating the obstacles. In some examples, the virtual object can be generated by the controller in real time based on the perception data. For example, the perception information may include point cloud data, and the controller can generate a three-dimensional model of the obstacle in real time based on the point cloud data.

In block 308, the controller controls the display screen to display a vehicle image of the vehicle, an environmental image, and a virtual object of an obstacle. The vehicle image may be a predefined image corresponding to the vehicle and used to indicate the vehicle on which the aforementioned radar and camera are deployed. Exemplarily, the vehicle image may be the vehicle image 211 in the preceding FIG. 2A. In some examples, the vehicle image, the environmental image, and the virtual objects of obstacles may be independently displayed at different positions on the display screen. Exemplarily, in the aforementioned scenario 200, the vehicle image 211 may be displayed in the middle of the display screen 209 and the environmental image 206 may be displayed in the upper right position of the display screen 209. In some examples, the vehicle image, the environmental image, and the virtual objects of obstacles may be displayed in combination, for example, as shown in the preceding FIG. 2B. It should be understood that the vehicle image, environmental image, and virtual objects displayed on the display screen may indicate the positions of obstacles in the real environment relative to the vehicle.

Through the above technical solution, the content displayed on the display screen includes not only the environmental image captured by the cameras, but also the virtual objects of obstacles determined based on the perception information of the radar. That is, more content may be displayed on the display screen so that limitations caused by displaying only the environmental images acquired by the cameras may be avoided, such as inaccuracies on the display screen in the event of camera failure. In this way, the state of the environment surrounding the vehicle can be more clearly indicated, and the user may be made more aware and conveniently informed of the environment around the vehicle through the display screen, thereby improving the user experience.

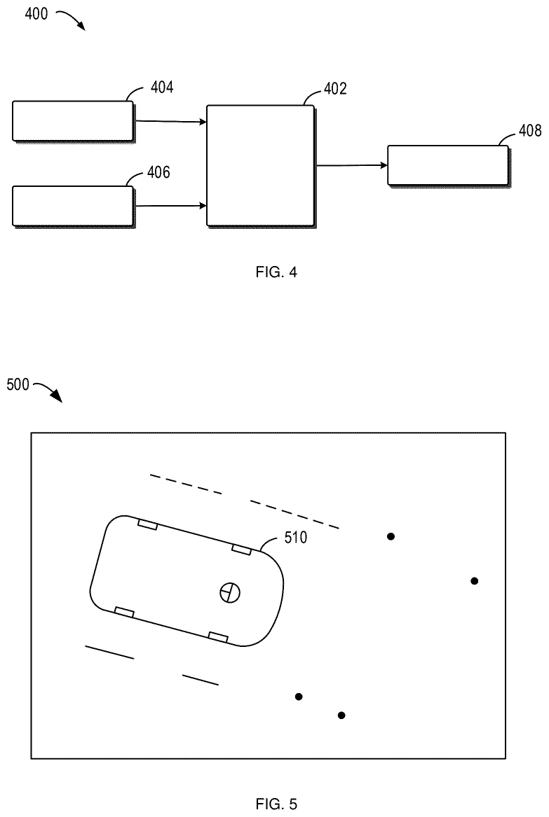

FIG. 4 shows a schematic view of a scenario 400 for displaying obstacles in some examples of the present disclosure. The scenario 400 comprises a controller 402, cameras 404, a radar 406, and a display 408. The controller 402 may be deployed in the vehicle or may be a device independent of the vehicle, and the controller 402 may be implemented via software and/or hardware. In some examples, the controller 402 may be, for example, an ECU in the vehicle 101.

The cameras 404 and the radar 406 may be deployed in the same vehicle, such as the vehicle 101 in the aforementioned scenario 100. The cameras 404 can capture images of the environment around the vehicle and the radar 406 can sense the environment by emitting detection signals and receiving echo signals reflected by obstacles to generate perception information. In some examples, the environmental image captured by the cameras 404 may include an image of an obstacle.

The controller 402 may perform the aforementioned method 300. For example, the controller 402 may acquire the environmental images captured by the cameras 404 as well as the perception information of the radar 406 by the methods described in the preceding blocks 302 and 304. The controller 402 may determine the virtual object of the obstacle based on the perception information by the method in block 306 above. The controller 402 may control the display screen 408 to display the environmental image and the virtual object by the method in block 308 above.

In some examples, the perception information of the radar 406 acquired by the controller 402 may include the outline, size, height, distance, etc. of the obstacle. In some examples, the radar 406 may classify obstacles and the perception information acquired by the controller 402 may include the classified information indicating the obstacle. In some examples, the radar 406 may divide the obstacle into point and line obstacles based on the width of the obstacle. For example, in the perception information of the radar 406, point obstacles may be represented with points and line obstacles may be represented with lines. In some examples, the radar 406 may classify obstacles based on their height. For example, the height of an obstacle can be determined and compared to a predefined height threshold to classify the obstacle as “high” or “low.” As one example, FIG. 5 shows a schematic diagram of the perception information 500 in some examples of the present disclosure. In the perception information 500, points can represent a point obstacle, lines can represent the outline of a line obstacle, solid lines can represent an obstacle with a height of “high,” and dotted lines can represent an obstacle with a height of “low.” For a clearer illustration, a vehicle image 510 corresponding to the vehicle is also shown in FIG. 5.

It should be understood that the above description of the perception information in conjunction with FIG. 5 is merely an example of some examples of the present disclosure and should not be construed as a limitation of the present disclosure. For example, in some examples, more or fewer categories may also be included in the perception information. In some examples, the radar 406 may not classify obstacles and the perception information acquired by the controller 402 may be raw data collected by the radar 406. In some examples, the controller 402 may determine the type of obstacle based on the raw data collected by the radar 406, classifying the obstacle.

The controller 402 may determine a virtual object for the obstacle based on the perception information of the radar 406. The virtual object of the obstacle may be determined by the controller 402 from a predefined set of a plurality of virtual objects. Exemplarily, the local memory of the controller 402 may store a predefined set of virtual objects including a plurality of predefined virtual objects that may have different types, outlines, and sizes, the controller 402 may determine the type, outline, and size of the obstacle based on the perception information of the radar 406 and match the type, outline, and size of the obstacle with the type, outline, and size of the virtual objects in the virtual object set to determine the virtual object with the same type, outline, and size as the obstacle as the virtual object of the obstacle.

In some examples, the virtual object of the obstacle may be modeled by the controller 402 based on the perception information of the radar 406. In some examples, when the controller 402 determines that there is no virtual object in the predefined set of virtual objects that matches the outline and size of the obstacle, it may model a new virtual object corresponding to the obstacle based on the perception information of the radar 406.

In some examples, the perception information of the radar 406 may include information indicative of the height of the obstacle and the controller 402 may further control the display screen 408 to display information associated with the height of the obstacle. For example, in some examples, the controller 402 can control the display screen 408 to display the environmental image, the vehicle image, and the virtual object of the obstacle while controlling the display screen 408 to display the height of the obstacle by displaying a numerical value. The numerical value can be displayed on the side of the virtual object of the obstacle or at the top of the display screen 408. The present disclosure does not limit this. In some examples, the controller 402 can adjust the size of the virtual object of the obstacle based on the environmental image displayed on the display screen 408 such that the size ratio of the virtual object in the display screen 408 relative to the environmental image is equal to the height ratio of the obstacle relative to the environment in which it is located in the real environment, thereby visually reflecting the height of the obstacle through the display screen 408.

In some examples, the perception information of the radar 406 may include information indicative of the distance between the obstacle and the vehicle and the controller 402 may further control the display screen 408 to display information associated with the distance to the obstacle. Exemplarily, in some examples, the distance between the obstacle and the vehicle may be reflected by controlling the relative distance between the displayed vehicle image and the virtual object. The controller 402 can determine the distance between the obstacle and the vehicle in the real environment based on the perception information of the radar 406 (referred to as the first distance for the sake of differentiation and explanation). In the process of the controller 402 controlling the display screen 408 to display the vehicle image, the environmental image, and the virtual object of the obstacle, the controller 402 can control the distance between the virtual object of the obstacle displayed on the display screen 408 and the vehicle image (referred to as the second distance for the sake of differentiation and explanation) based on the first distance. For example, the second distance may be proportional to the first distance. In some examples, the controller 402 may control the display screen 408 to display the distance between the obstacle and the vehicle by displaying a numerical value. In some examples, the controller 402 may control the display screen 408 to display the distance between the obstacle and the vehicle and/or the height of the obstacle in a numerical manner when determining that the distance between the obstacle and the vehicle is less than a predetermined distance threshold.

In some examples, the controller 402 may determine the position of the obstacle relative to the vehicle based on the perception information of the radar 406 and control the display screen 408 to display a virtual object of the obstacle at a position corresponding to the vehicle image. In some examples, the controller 402 may control the display screen 408 to simultaneously display the distance between the obstacle and the vehicle, the height of the obstacle, and the direction of the obstacle relative to the vehicle. In this way, the virtual object displayed on the display screen can clearly reflect the location, height, distance, etc. of the obstacle in the real environment, thereby enabling the user to clearly determine the true state of the environment and improving the driving experience.

It should be understood that the scenario 400 shown in FIG. 4 for displaying obstacles is only one example among the examples of the present disclosure and should not be construed as a limitation on the examples of the present disclosure. For example, in some examples, the controller 402 may also acquire environmental images from a plurality of cameras. In some examples, the controller 402 may obtain perception information from a plurality of radars. In some examples, the controller 402 may control images displayed on a plurality of display screens. In some examples, the functions of the controller 402 may be achieved by one or more modules. In some examples, the controller 402, the cameras 404, the radars 406, and/or the display screens 408 may be deployed in the same device or may be deployed in different devices. In some examples, the cameras 404 and the radars 406 may be deployed in the same vehicle or may each be deployed in a roadside device or other device and the controller 402 may acquire the environmental images captured by the cameras 404 and the perception information of the radars 406 in a wired or wireless manner.

In some examples, the controller 402 may control the display screen 408 to display a vehicle image and an environmental image and may control the display screen 408 to display virtual objects when certain conditions are met. Exemplarily, upon receiving instruction information entered by the user, the controller 402 may control the display screen 408 to display a virtual object of an obstacle. In some examples, the control device 402 may receive the user's instruction to display virtual object indication information on the display screen 408 through the display screen 408 or a button.

In some examples, the controller 402 may determine whether the cameras 404 can accurately capture images of obstacles around the vehicle and control the display screen 408 to display virtual objects if the cameras 404 cannot accurately capture images of obstacles around the vehicle. For example, in some examples, the controller 402 can determine the perception performance level of the cameras 404 based on the resolution of the environmental images acquired by the cameras 404 and compare the perception performance level to a predetermined perception performance level. If the perception performance level of the cameras 404 is lower than the predetermined perception performance level, it is determined that the cameras 404 cannot accurately capture images of obstacles around the vehicle. In this case, the radars 406 are used to detect obstacles in the environment and the display screen 408 is controlled to display virtual objects of the obstacles.

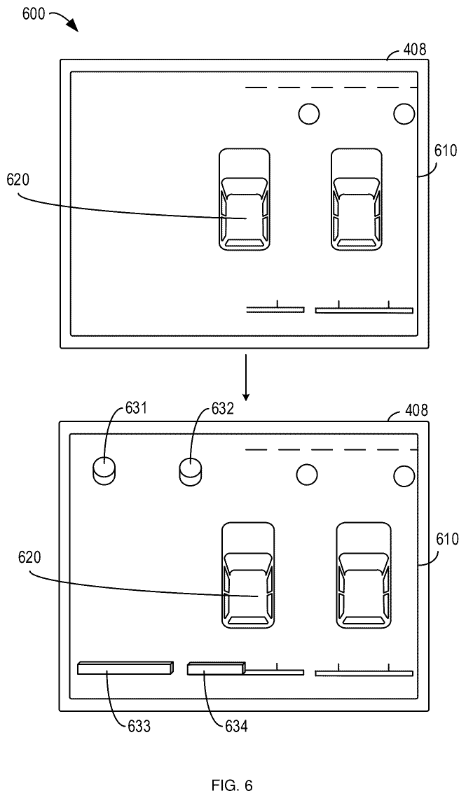

Exemplarily, FIG. 6 shows a schematic view showing content displayed on a display screen 408 in some examples of the present disclosure. As shown in FIG. 6, the display 408 may display an environmental image 610 and a vehicle image 620. The vehicle image 620 may correspond, for example, to the vehicle 101 of the preceding FIGS. 1 and 2A. The environmental image 610 may be, for example, an image obtained by combining the environmental image 206 captured by the camera 202 and the environmental image 208 captured by the camera 204 in FIG. 2A. For reasons such as malfunction of the camera 201 and the camera 203 configured in vehicle 101, the camera 201 and the camera 203 cannot clearly capture the environment and cannot obtain environmental image 205 and environmental image 207. As a result, the environmental image 610 displayed on the display screen 408 does not include complete images corresponding to obstacles 103, 104, 107, and 108. The controller 402 can recognize that the camera 201 and the camera 203 have malfunctioned and, based on the perception information of the radar 406, determine the virtual objects 631, 632, 633, and 634 corresponding to the obstacles 103, 104, 107, and 108, respectively, and control the display screen 408 to display the virtual objects 631, 632, 633, and 634 together with the environmental image 610 and the vehicle image 620.

In some examples, the controller 402 may identify the environmental image captured by the camera 404 based on the user's instruction information to determine if the vehicle is in a parking scenario. The controller 402 may then control the display screen 408 to display a virtual image of the obstacle in the event that the vehicle is determined to be in a parking scenario. That is, the controller 402 may perform the above method 300 only when the vehicle is in a parking scenario. In some examples, when it is determined that the vehicle is in a parking scenario, the controller 402 can obtain a plurality of environmental images captured by a plurality of cameras to generate a panoramic image around the vehicle and the environmental image displayed on the display screen 408 can be the panoramic image.

In some examples, virtual objects of obstacles whose distance from the vehicle exceeds a predetermined distance threshold may not be displayed on the display screen 408. Exemplarily, in the scenario 100, there may be more obstacles around the vehicle 101, and these obstacles are farther away from the vehicle 101, e.g., exceeding a predetermined distance threshold (e.g., 2 meters, 3 meters, etc.). The controller 402 may control the display screen 408 to not display the virtual objects of these obstacles. That is, when an obstacle approaches the vehicle, the display screen 408 can be controlled to display a virtual object of the obstacle.

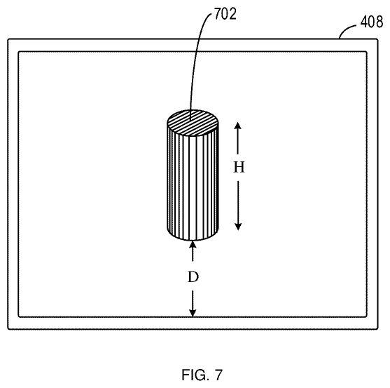

In some examples, when it is determined that the distance between the obstacle and the vehicle is less than a predetermined distance threshold, the controller 402 may control the display screen 408 to display a new interface; e.g., the display screen 408 may be controlled to display a new virtual object of the obstacle. By way of example, this process is illustrated in FIG. 7. FIG. 7 shows a schematic view showing content displayed on a display screen 408 according to some examples of the present disclosure. As shown in FIG. 7, the display screen 408 may display content at a specific angle including a virtual object 702, which may be, for example, the obstacle 104 in the aforementioned scenario 100 and may correspond to the virtual object 222 displayed on the display screen 209 in FIG. 2B. The controller 402 can determine the distance between the obstacle and the vehicle 101 while controlling the display screen 408 to display the content shown in FIG. 2B. When the distance between the obstacle 104 and the vehicle 101 is less than a predetermined distance threshold, the controller 402 can control the display screen 408 to display content at a specific angle including the virtual object 702 as shown in FIG. 7.

In some examples, in the display interface shown in FIG. 7, the controller 402 may also control the display screen 408 to display the distance D between the obstacle 104 and the vehicle as well as the height H of the obstacle 104 in the real environment. In some examples, while controlling the display screen to display the virtual object 702, the controller 402 may also control the display screen 408 to display a localized environmental image including an image of the obstacle 104 captured by a single camera. In this way, obstacles close to the vehicle can be displayed more clearly, thereby improving the user experience.

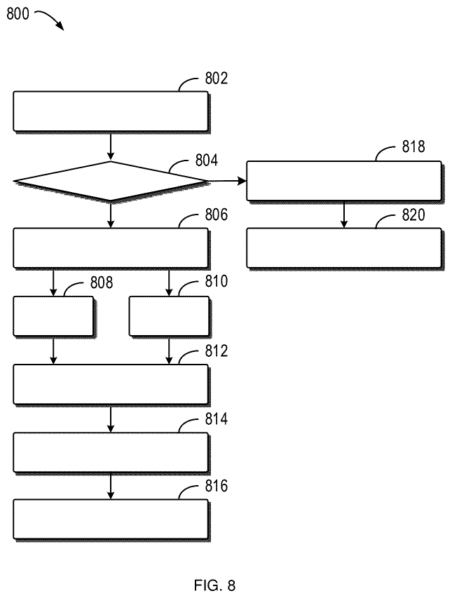

FIG. 8 shows a flow chart of a method 800 for displaying obstacles according to some examples of the present disclosure. The method shown in FIG. 8 may be executed by a controller, which may be, e.g., the aforementioned controller 402 or, e.g., an ECU configured in the vehicle. For ease of illustration, the method 800 is schematically described below by taking a controller as the execution entity. As shown in FIG. 8, the method 800 may include blocks 802 to 820.

In block 802, the controller obtains a request from the user to perceive the surrounding environment. In block 804, the controller determines whether a virtual object needs to be displayed on the display screen, e.g., whether instruction information entered by a user instructing it to display the virtual object has been received. If yes, block 806 is executed, and if no, block 818 is executed. In block 806, the controller receives the environmental images captured by the cameras as well as the perception information of the radar. In block 808, the controller determines the type and size of the obstacle based on the perception information of the radar, and in block 810, the controller determines the location of the obstacle based on the perception information of the radar. In block 812, the controller determines a virtual object associated with the obstacle. In block 814, the controller determines the location of the virtual object of the obstacle in an environmental image captured by the camera based on the location of the obstacle. In block 816, the controller controls the display screen to display the environmental image, the vehicle image, and the virtual object of the obstacle. In block 818, the controller receives the environmental image captured by the camera. In block 820, the controller controls the display screen to display the vehicle image and the environmental image.

It should be understood that the steps of the method for displaying obstacles in the examples of the present disclosure are merely illustrative and should not be construed as a limitation on the examples of the present disclosure. For example, the method 800 may also include more or fewer steps. Through the method of the present disclosure, it is possible to display information related to the environment in the form of images and to present obstacles in the environment in the form of virtual objects on a display screen so that the overall environmental information can be presented on the display screen better and more clearly, thereby improving the user experience. Even if the cameras cannot accurately capture images of the vehicle's surroundings, it can accurately present obstacles in the environment around the vehicle to the user in the form of virtual objects, which can enhance the user's driving experience.

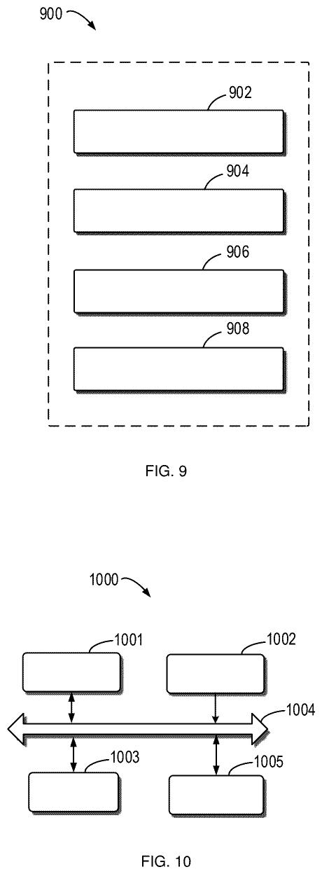

FIG. 9 shows a block diagram of an apparatus 900 for displaying obstacles according to some examples of the present disclosure. The apparatus 900 may correspond, e.g., to a controller in the examples of the above method. As shown in FIG. 9, the apparatus 900 comprises a first acquisition unit 902 configured to acquire an environmental image acquired by a camera of a vehicle. The apparatus 900 further comprises a second acquisition unit 904 configured to acquire perception information of a radar of the vehicle. The apparatus 900 further comprises an image determination unit 906 configured to determine a virtual object of an obstacle around the vehicle based on the perception information. In addition, the apparatus 900 further comprises a display unit 908 configured to display a vehicle image of the vehicle, an environment, and virtual objects of obstacles.

In some examples, the image determination unit 906 further comprises: a first determination unit configured to determine the outline and size of the obstacle based on the perception information; and a second determination unit configured to determine the virtual object of the obstacle from a predefined set of virtual objects based on the outline and size.

In some examples, the apparatus 900 further includes a third determination unit configured to determine the direction of the obstacle relative to the vehicle and a first distance between the obstacle and the vehicle based on the perception information. The display unit 908 further comprises a first display unit configured to display a vehicle image and an environmental image and to display a virtual object of the obstacle in the direction of the vehicle image and at a second distance from the vehicle image, wherein the second distance is associated with the first distance.

In some examples, the third determination unit further comprises a fourth determination unit configured to determine the height of the obstacle based on the perception information. The apparatus 900 further comprises a second display unit configured to display the first distance and the height of the obstacle.

In some examples, the apparatus 900 further comprises a distance judgment unit configured to determine that the first distance is less than a predetermined distance threshold before the second display unit displays the first distance and the height of the obstacle.

In some examples, the apparatus 900 further comprises: a fifth determination unit configured to determine a second virtual object of the obstacle based on the height of the obstacle, wherein the second virtual object has height information associated with the height of the obstacle; and a third display unit configured to display target content on a display screen, wherein the target content comprises the second virtual object and the first distance.

In some examples, the apparatus 900 further comprises: a fourth display unit configured to display an environmental image before the second acquisition unit 904 acquires the perception information of the radar; and an indication information receiving unit configured to receive indication information entered by the user before the second acquisition unit 904 acquires the perception information of the radar, wherein the indication information is used to instruct the display of a virtual object on the display screen.

In some examples, the apparatus 900 further comprises: a sixth determination unit configured to determine the perception performance level of the camera based on the environmental image before the second acquisition unit 904 acquires the perception information of the radar; and a seventh determination unit configured to determine that the perception performance level of the camera is lower than a predetermined perception performance level before the second acquisition unit 904 acquires the perception information of the radar.

In some examples, the apparatus 900 further comprises an eighth determination unit configured to determine that the vehicle is in a parking scenario. The first acquisition unit 902 further comprises a third acquisition unit configured to acquire a panoramic image of the surroundings of the vehicle captured by the camera. The display unit 908 further comprises a fifth display unit configured to display the vehicle image, the panoramic image, and virtual objects of obstacles.

FIG. 10 illustrates a schematic block diagram of a controller 1000 suitable for use in implementing examples of the present application. The controller 1000, e.g., may correspond to the controller described in the method examples above. As shown in FIG. 10, the controller 1000 comprises a processor 1001, which can perform various appropriate actions and processes according to computer program instructions stored in a read-only memory (ROM) 1002 and loaded into a random-access memory (RAM) 1003. Various programs and data required for the operation of the controller 1000 may also be stored in the RAM 1003. The processor 1001, the ROM 1002, and the RAM 1003 are interconnected through a bus 1004. An input/output (I/O) interface 1005 is also connected to the bus 1004.

The various methods or processes described above, such as the method 300 and the method 800, may be performed by the processor 1001. For example, in some examples, the method 300 can be implemented as a computer software program tangibly contained in a machine-readable medium. In some examples, part or all of the computer programs may be loaded and/or installed onto the controller 1000 through the ROM 1002. When the computer program is loaded and executed by the processor 1001, one or more steps or actions of the method or process described above can be performed.

The functions described above herein can be performed, at least in part, by one or more hardware logic components. For example, and without limitation, exemplary types of hardware logic components that can be used comprise: Field Programmable Gate Arrays (FPGA), Application Specific Integrated Circuits (ASIC), Application Specific Standard Products (ASSP), System on a Chip (SOC), Complex Programmable Logic Devices (CPLD), and the like.

The program code for implementing the methods of the present disclosure can be written in any combination of one or more programming languages. This program code can be provided to a processor or controller of a general-purpose computer, special-purpose computer, or other programmable data processing devices such that the program code, when executed by the processor or controller, causes the functions/operations specified in the flowcharts and/or block diagrams to be implemented. The program code can be executed entirely on the machine, partly on the machine, as a stand-alone software package partly on the machine and partly on a remote machine, or entirely on a remote machine or server.

In the context of the present disclosure, a machine-readable medium can be a tangible medium that can contain or store programs for use by or in conjunction with an instruction execution system, apparatus, or device. A machine-readable medium can be a machine-readable signal medium or a machine-readable storage medium. The machine-readable medium can comprise, but is not limited to, electronic, magnetic, optical, electromagnetic, infrared, or semiconductor systems, apparatuses, or devices, or any suitable combination of the foregoing. More specific examples of the machine-readable storage medium would comprise electrical connections based on one or more wires, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

Although the subject matter has been described in language specific to structural features and/or methodological acts, it is to be understood that the subject matter defined in the appended patent claims is not necessarily limited to the specific features or acts described above. Rather, the specific features and operations described above are merely exemplary forms of implementing the subject matter defined by the patent claims.

What is claimed is:

1. A method for displaying an obstacle, comprising:
acquiring an environmental image captured by a camera of a vehicle;
acquiring perception information from a radar of the vehicle;
determining, based on the perception information, a virtual object of an obstacle around the vehicle; and
displaying a vehicle image of the vehicle, the environmental image, and the virtual object of the obstacle on a display screen.

2. The method according to claim 1, wherein determining, based on the perception information, a virtual object of an obstacle around the vehicle comprises:
determining the outline and size of the obstacle based on the perception information; and
determining the virtual object of the obstacle from a predefined set of virtual objects based on the outline and size.

3. The method according to claim 1, further comprising:
determining the direction of the obstacle relative to the vehicle and a first distance between the obstacle and the vehicle based on the perception information;
and wherein displaying a vehicle image of the vehicle, the environmental image, and the virtual object of the obstacle on the display screen comprises:
displaying the vehicle image and the environmental image on the display screen, and
displaying a virtual object of the obstacle in the direction of the vehicle image and at a second distance from the vehicle image, wherein the second distance is associated with the first distance.

4. The method according to claim 3, further comprising:
determining the height of the obstacle based on the perception information; and
displaying the first distance and the height of the obstacle on the display screen.

5. The method according to claim 4, wherein prior to displaying the first distance and the height of the obstacle on the display screen, the method further comprises:
determining that the first distance is less than a predetermined distance threshold.

6. The method according to claim 5, wherein displaying the first distance and the height of the obstacle on the display screen comprises:
determining a second virtual object of the obstacle based on the height of the obstacle, wherein the second virtual object has height information associated with the height of the obstacle; and
displaying target content on the display screen, wherein the target content comprises the second virtual object and the first distance.

7. The method according to claim 1, wherein prior to acquiring the perception information of a radar of the vehicle, the method further comprises:
displaying the environmental image on the display screen; and
receiving indication information entered by the user, wherein the indication information is used to instruct the display of a virtual object on the display screen.

8. The method according to claim 1, wherein prior to acquiring the perception information of a radar of the vehicle, the method further comprises:
determining the perception performance level of the camera based on the environmental image; and
determining that the perception performance level is lower than a predetermined perception performance level.

9. The method according to claim 1, wherein prior to displaying the vehicle image of the vehicle, the environmental image, and the virtual object of the obstacle on the display screen, the method further comprises:
determining that the vehicle is in a parking scenario;
wherein acquiring an environmental image acquired by a camera of the vehicle comprises:
acquiring a panoramic image of the surroundings of the vehicle captured by the camera;
and wherein displaying a vehicle image of the vehicle, the environmental image, and the virtual object of the obstacle on a display screen comprises:
displaying the vehicle image, the panoramic image, and the virtual object on the display screen.

10. An apparatus for displaying an obstacle, comprising:
a first acquisition unit configured to acquire an environmental image captured by a camera of a vehicle;
a second acquisition unit configured to acquire perception information of a radar of the vehicle;
an image determination unit configured to determine a virtual object of an obstacle around the vehicle based on the perception information; and
a display unit configured to display the vehicle image of the vehicle, the environmental image, and the virtual object of the obstacle.

11. A controller, comprising:
at least one processor; and
a memory, coupled to the at least one processor, and having instructions stored thereon, wherein the instructions, when executed by the at least one processor, cause the controller to perform the method according to claim 1.

12. A vehicle, comprising the controller according to claim 11.

13. A computer program product comprising computer-executable instructions that, when executed, cause the computer to perform the steps of the method according to claim 1.
